(19) United States
(12) Patent Application Publication
(10) Pub. No.: US 2022/0312660 A1
(43) Pub. Date: Oct. 6, 2022

(54) Digging and Boring Bar

(71) Applicant: Jose S. Hernandez, Missouri City, TX (US)

(72) Inventor: Jose S. Hernandez, Missouri City, TX (US)

(21) Appl. No.: 17/712,240

(22) Filed: Apr. 4, 2022

Related U.S. Application Data
(60) Provisional application No. 63/171,245, filed on Apr. 6, 2021.

(51) Int. Cl. A01B 1/20

(52) U.S. Cl. CPC A01B 1/20

(57) ABSTRACT

The present invention relates to a sidewalk and driveway digging and boring bar device. The bar is designed for excavating a cavity underneath a sidewalk area to accommodate piping and wiring, and also for removing dirt and debris from the cavity. The bar features an elongated shaft having a first end and a second end, wherein a pointed head is permanently secured to the first end of the elongated shaft, and a rounded head portion is permanently secured to the second end of the elongated shaft. The pointed head has a pointed end for penetrating the sidewalk to create a cavity in the sidewalk and the rounded head is used for removing dirt and debris from the created cavity. The bar is inserted into the sidewalk by holding the elongated shaft and applying a downward force.

### CROSS-REFERENCE TO RELATED APPLICATION

The present application claims priority to, and the benefit of, U.S. Provisional Application No. 63/171,245, which was filed on Apr. 6, 2021 and is incorporated herein by reference in its entirety.

### FIELD OF THE INVENTION

The present invention relates generally to surface digging tools. More specifically, the present invention relates to a sidewalk and driveway digging and boring tool that is used for digging out a cavity underneath a sidewalk area. The driveway or sidewalk digging and boring tool includes a pointed head, an elongated shaft and a rounded top portion. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, a sidewalk is a path along the side of a road, which is usually constructed of concrete or asphalt, and designed for pedestrian traffic. A sidewalk may accommodate moderate changes in height and is normally separated from the vehicular section of the road by a curb. Generally, sidewalks have hoses, PVC pipes, drainpipes and electrical wires underneath them which are used for residential drainage systems, electric connections and/or water supplies.

When pipelines need to be inserted underneath sidewalks and driveways, cavities and trenches are created. Electricians, cable companies, homeowners and others find it tedious and difficult to dig holes and cavities to run pipelines underneath the sidewalks. Users may have to bend and sit when digging cavities using handheld tools. Further, other tools for digging cavities are heavy and difficult to transport.

Generally, homeowners need professional help when digging even small holes in sidewalks. Further, electricians, cable companies and other companies need to carry expensive and heavy machines when creating trenches and cavities. Thus, it is desired to have a portable, lightweight, sturdy tool for creating cavities and trenches in sidewalks and driveways.

Even when the holes and cavities are created, a large amount of debris and dust accumulates within the holes, requiring users to utilize a boring device to remove the excess dirt. Thus, it is desired to have a singular tool for digging and removing dirt and debris.

Therefore, there exists a long felt need in the art for a portable digging and boring tool that can be easily used by both homeowners and professionals. There is also a long felt need in the art for a portable digging and boring tool that can easily dig out a cavity underneath a sidewalk area. Additionally, there is a long felt need in the art for a portable digging and boring tool that removes dirt and debris from the cavity. Further, there is a long felt need in the art for a portable digging and boring tool that saves time and labor for electricians, plumbers, lighting companies, irrigators and more. Moreover, there is a long felt need in the art for a portable digging and boring tool that digs out desired wiring and piping cavities with minimal waste. Finally, there is a long felt need in the art for a portable digging and boring tool that digs a cavity while removing excess soil and other debris.

The subject matter disclosed and claimed herein, in one embodiment thereof, comprises a sidewalk digging and boring bar. The digging and boring bar excavates a cavity underneath a sidewalk area to accommodate piping and wiring. The sidewalk digging bar includes an elongated shaft that has two ends. A pointed head is permanently joined to a first end of the elongated shaft and a rounded head portion is permanently connected to the other end of the elongated shaft. The pointed head has a pointed end for penetrating into the sidewalk to create a cavity in the sidewalk, and the rounded head is used for removing dirt and debris from the created cavity, and wherein the bar is pushed into the sidewalk by holding the shaft.

In this manner, the sidewalk digging and boring bar of the present invention accomplishes all of the forgoing objectives and provides a relatively easy, lightweight and convenient apparatus that can be used by both homeowners and professionals. The digging and boring bar features a pointed tip and a rounded top, thereby allowing both the digging and removing of dirt. The sidewalk digging and boring bar can be used by homeowners, electricians, plumbers, lighting companies, irrigators, etc.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a sidewalk digging bar device. The sidewalk digging bar device is designed for excavating a cavity underneath a sidewalk area to accommodate piping and wiring. The sidewalk digging bar device comprises an elongated shaft having a first and a second end, wherein a pointed head is permanently secured to the first end of the elongated shaft, and a rounded head portion is permanently secured to the second end of the elongated shaft. The pointed head comprises a pointed end for penetrating into a sidewalk surface to create a cavity in the sidewalk, and the rounded head is used for removing dirt and debris from the created cavity. Further, the sidewalk digging bar device is inserted and pushed into the sidewalk by holding the elongated shaft.

In yet another embodiment of the present invention, the elongated shaft comprises ergonomic grips for securely handling the elongated shaft without it slipping from a user's grip during use. Further, the ergonomic grips do not slide on the elongated shaft and provide a user with a comfortable grip.

In yet another embodiment of the present invention, a digging and boring bar device is disclosed. The digging and boring bar device includes a pointed head for breaking and excavating a sidewalk surface, to create a cavity for wiring and piping underneath a sidewalk and a rounded head portion for enlarging and smoothing the created cavity and removing debris and dust from said cavity. Further, the pointed head and the rounded head are permanently secured to opposing ends of an elongated telescoping shaft. The telescoping shaft, the pointed head and the rounded head are molded as a single unit. The telescoping shaft comprises a plurality of telescoping slots for extending and retracting the length of the shaft as per the needs and/or wants of a user.

In another embodiment of the present invention, the digging and boring bar device is used to create cavities for PVC pipes, hoses, electrical wires and/or plumbing connections. The digging and boring bar device is used for creating cavities in dirt, soil, mortar, mulch, snow, ice, gravel, sand and ore, etc.

In a further embodiment of the present invention, a method for excavating wiring and piping cavities in a sidewalk or any other surface is described. The method includes identifying a location for creating a cavity in a surface, positioning a pointed tip of a boring bar onto the location, wherein the pointed tip is permanently secured to a shaft, pushing and inserting the pointed tip into the location by applying a downward force on the shaft to create the cavity and removing debris and dirt from said cavity using a rounded head that is permanently secured to a second end of the shaft.

Advantageously, the digging and boring bar device of the present invention allows electricians, plumbers, lighting companies, irrigators, etc., to excavate desired wiring and piping cavities with minimal material waste and/or effort. A single device is used for both creating cavities and removing dirt, soil and/or debris from the cavities.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the driveway or sidewalk digging bar device of the present invention in accordance with the disclosed architecture;

FIG. 2A illustrates a perspective view of one potential embodiment of the pointed head of the driveway or sidewalk digging bar device of the present invention in accordance with the disclosed architecture;

FIG. 2B illustrates a perspective view of another potential embodiment of the pointed head of the driveway or sidewalk digging bar device of the present invention in accordance with the disclosed architecture;

FIG. 2C illustrates a perspective view of another potential embodiment of the pointed head of the driveway or sidewalk digging bar device of the present invention in accordance with the disclosed architecture;

FIG. 3 illustrates a perspective view of another potential embodiment of the driveway or sidewalk digging bar device of the present invention with a pointed head and a rounded head in accordance with the disclosed architecture;

FIG. 4 illustrates a close-up view of one potential embodiment of the rounded head of the driveway or sidewalk digging bar device of the present invention in accordance with the disclosed architecture; and

FIG. 5 illustrates a perspective view of one potential embodiment of the driveway or sidewalk digging bar device of the present invention in use in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a portable digging and boring tool device that can be easily used by both homeowners and professionals. There is also a long felt need in the art for a portable digging and boring tool device that easily excavates a cavity underneath a sidewalk area. Additionally, there is a long felt need in the art for a portable digging and boring tool device that removes dirt and debris from the cavity. Further, there is a long felt need in the art for a portable digging and boring tool device which saves time and labor for electricians, plumbers, lighting companies, irrigators, etc. Moreover, there is a long felt need in the art for a portable digging and boring tool device that excavates the desired wiring and piping cavities with minimal waste. Finally, there is a long felt need in the art for a portable digging and boring tool device that excavates a cavity and removes the excess soil and other debris.

The present invention, in one exemplary embodiment, is a digging and boring bar device. The digging and boring bar device comprises a pointed head for penetrating and excavating a surface, to create a cavity for wiring, piping, etc., and a rounded head portion for enlarging and smoothing the created cavity and removing debris and dust from said cavity. The pointed head and the rounded head are permanently secured to opposing ends of an elongated telescoping shaft and wherein the telescoping shaft, the pointed head and the rounded head are molded as a single unit.

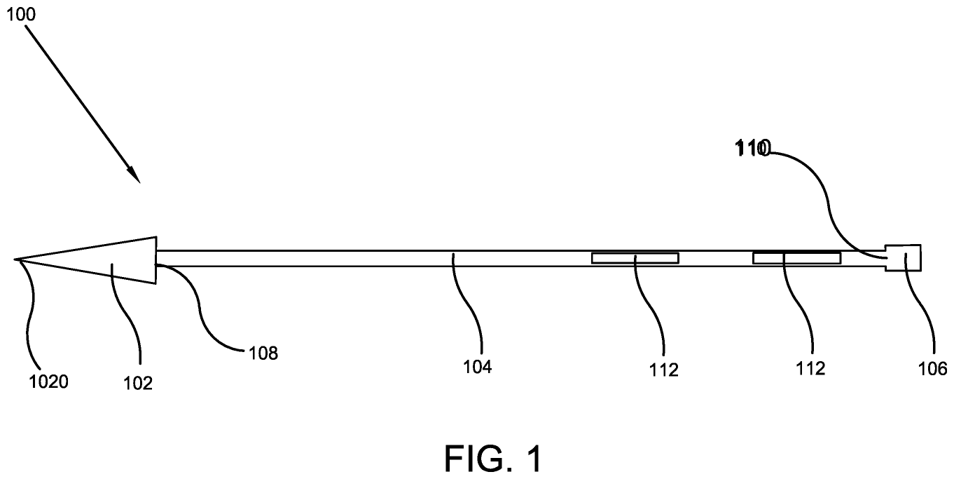

Referring initially to the drawings, FIG. 1 illustrates a perspective view of one embodiment of the sidewalk digging bar device of the present invention. The sidewalk digging bar device 100 is configured to be used by homeowners, electricians, plumbers, cable installers, etc., or any other suitable user as is known in the art, for creating a hole or cavity underneath a sidewalk or other hard surface area in which to run piping/wiring, etc. More specifically, the digging bar device 100 comprises a pointed head 102 permanently secured to a first end 108 of an elongated tubular shaft 104. The pointed head 102 comprises a pointed tip 1020 which is used for penetrating and excavating the sidewalk or other hard surface area easily. The second end 110 of the elongated shaft 104 comprises a permanently secured rounded top element 106 for removing debris and cleaning out the excess dirt from the hole or cavity created by the pointed head 102. The elongated shaft 104 is manufactured of a metal, such as steel, aluminum, titanium, etc., or any other suitable metal as is known in the art, allowing a user to apply the required downward force to create a cavity without bending the shaft 104. In the present embodiment, the pointed head 102, the elongated shaft 104 and the rounded top element 106 are permanently secured together via welding, threaded connection, pin connection, etc., or any other suitable securing means as is known in the art. Alternatively, the pointed head 102, the elongated shaft 104 and the rounded top element 106 are cast together as a single-piece component from the same material.

For securely and comfortably gripping the elongated shaft 104 during the excavating process, ergonomic grips 112 are disposed along the elongated shaft 104 and are typically concentrated more towards the second end 110, but the ergonomic grips 112 can also be disposed anywhere along the elongated shaft 104, depending on the needs and/or wants of a user. For example, the ergonomic grips 112 can be disposed more towards the first end 108 of the elongated shaft 104 or disposed along both ends 108 and 110 of the elongated shaft 104. The ergonomic grips 112 can be manufactured of rubber, plastic or any other suitable gripping material as is known in the art, and are securely attached to and do not slide along the elongated shaft 104. The elongated shaft 104 is cylindrical in shape and has a substantial constant diameter along the length. However, the elongated shaft 104 can be any suitable shape as is known in the art based on the needs and/or wants of a user. The elongated shaft 104 can also be hollow, contributing to less overall weight along the shaft, which results in easy handling for the user. The pointed head 102 is solid and manufactured of a strong metal, such as steel, tungsten, aluminum, etc., or any other suitable metal as is known in the art, allowing the pointed tip 1020 to easily penetrate a surface and excavate a cavity within or underneath the surface. The pointed head 102 is heavier in weight than the elongated shaft 104 and the rounded top element 106 together, for increased utility and portability of the bar device 100. In the present embodiment, dimensions of the pointed head 102 are approximately 3″×9″ and dimensions of the elongated shaft 104 are approximately 6′×¾′.

The digging bar device 100 is used for excavating at least one of dirt, soil, mortar, mulch, snow, ice, gravel, sand, ore, etc., or any other material as is known in the art. The pointed head 102 specifically removes material away from a surface in order to create a hole or cavity. The pointed head 102 removes metal and/or other materials from the surface, creating a rounded hole or cavity in the process. The rounded head 106 is used for slightly enlarging the hole or cavity created by the pointed head 102, and for removing debris and excess dirt from the hole or cavity. The digging bar device 100 functions as a time-saving tool for electricians, plumbers, lighting companies, irrigators, etc., or any other suitable user as is known in the art, by excavating the desired wiring and piping cavities with minimal material waste and effort.

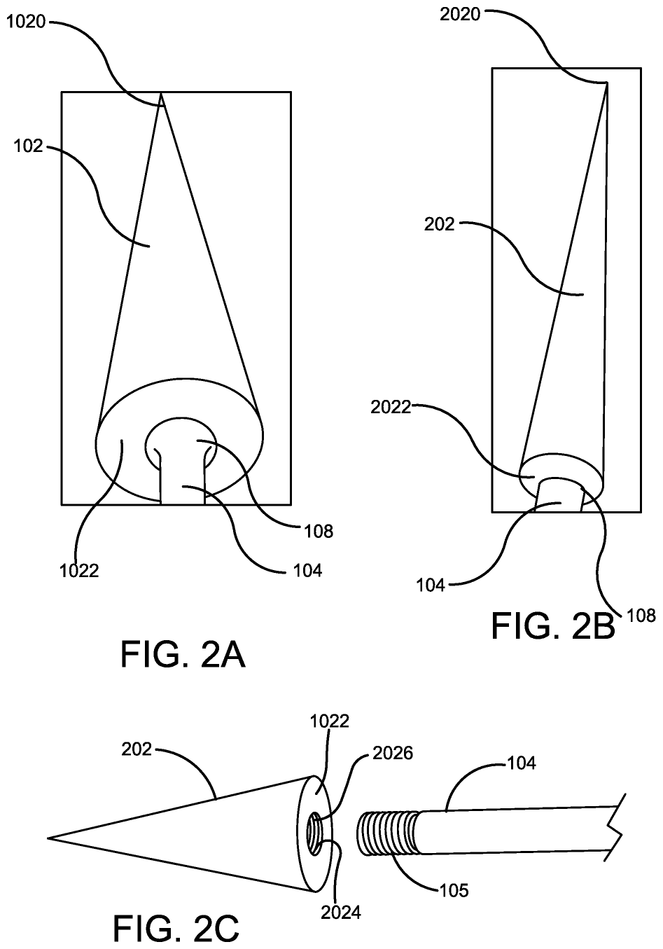

FIG. 2A illustrates a perspective view of one embodiment of the pointed head of the digging bar device. The pointed head 102 is made of a sturdy and durable metal, such as steel, aluminum, tungsten, etc., or any other suitable metal as is known in the art, for creating a hole or a cavity within or underneath a surface. The pointed head 102 is conical in shape, with a pointed end 1020. The pointed end 1020 is used like a nail head, thereby allowing a user to apply downward force to break apart the surface and create a desired hole or cavity. The pointed head 102 has a flat top surface 1022 to which the shaft 104 is permanently secured at a first end 108 of the shaft 104 via welding, a threaded connection, a pin connection, etc. The pointed head 102 is strong and can dig into hard surfaces such as mortar, gravel, etc., or any other suitable hard material as is known in the art. The dimensions of the pointed head 102 are approximately 3″×9″.

FIG. 2B illustrates a perspective view of another embodiment of the pointed head of the digging bar device. Here, the pointed head 202 is also conical in shape with a pointed end 2020, however the pointed head 202 is longer and narrower in dimension than the pointed head 102, allowing a user to excavate deeper while requiring less force. The narrowing pointed head 202 is made of a sturdy and durable metal such as steel, aluminum, tungsten, etc., or any other suitable metal as is known in the art, for creating a hole or a cavity within or underneath a surface. The narrowing pointed end 2020 is used like a nail head, thereby allowing a user to utilize less force to break apart the surface and create a desired hole or cavity. The narrowing pointed head 202 has a flat top surface 2022 to which the shaft 104 is permanently secured at a first end 108 of the shaft 104 via welding, threaded connection, pin connection, etc. The narrowing pointed head 202 is strong and can dig deep into hard surfaces such as mortar, gravel, etc., or any other suitable hard materials as is known in the art, as well as softer surfaces such as soil, dirt, etc., or any other suitable soft materials as are known in the art. The dimensions of the narrowing pointed head 202 are approximately 1.5″×9″.

FIG. 2C illustrates a perspective view of another potential embodiment of the pointed head of the driveway or sidewalk digging bar device of the present invention in accordance with the disclosed architecture. In this embodiment, the head 202 is further comprised of a semi-continuous opening 2024 that is further comprised of female threads 2026. The shaft 104 in this embodiment is comprised of a plurality of male threads 105 that engage the female threads 2026 of the head 202 such that the head 202 can be screwed on/off the shaft 104. Further, the bar device 100 may be comprised of a kit of a plurality of heads 202 that each contain semi-continuous openings 2024 with female threads 2026, and wherein each head 202 is of a differing size. In this manner, a specific head 202 size can be selected based on the specific job application.

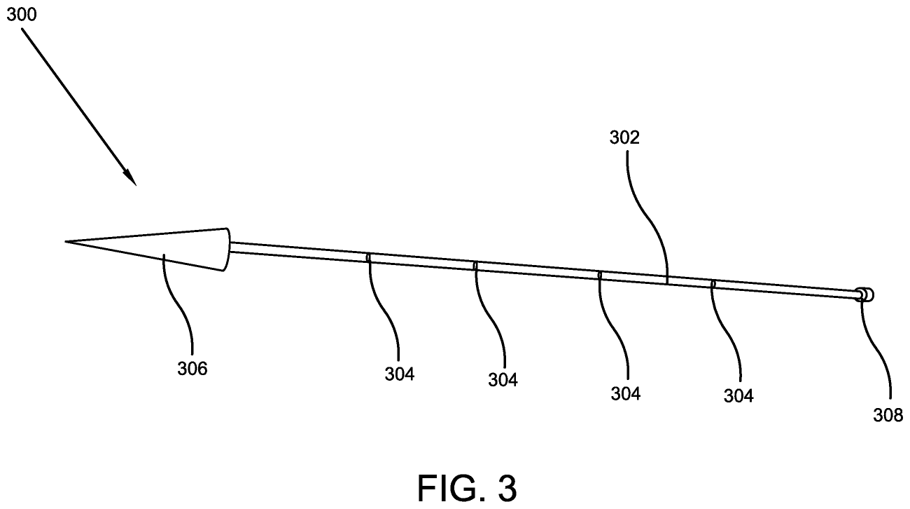

FIG. 3 illustrates a perspective view of another embodiment of the digging bar device of the present invention. In the present embodiment, the digging bar device 300 comprises a telescoping shaft 302, thereby allowing a user to adjust the length of the shaft 302 as per a user's needs and/or wants. The telescoping shaft 302 is useful to adjust the shaft length, which allows users of varying heights to use the bar device 300 easily. Specifically, the telescoping shaft 302 comprises a plurality of telescoping slots 304 that allows the shaft 302 to extend or retract. Further, the shaft 302 comprises a pointed head 306, which is used for excavating a cavity or hole, and a rounded top element 308, which is used for removing debris and excess dirt from the cavity.

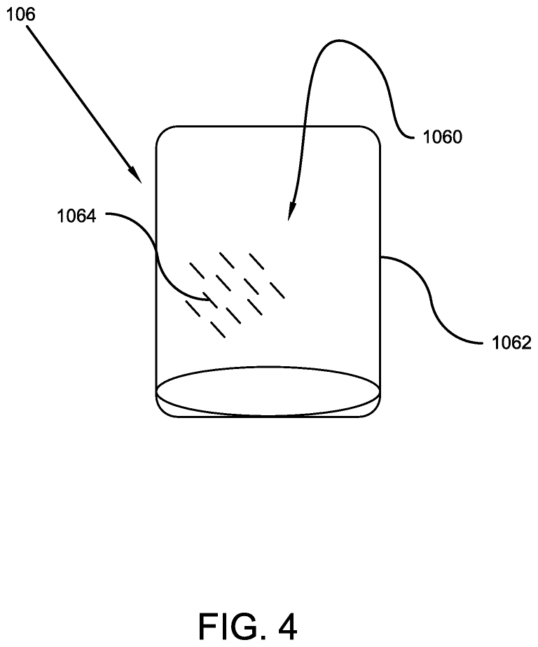

FIG. 4 illustrates a close-up view of the rounded top head of the digging bar device of the present invention. The rounded top head 106 and 308 used in different embodiments of the present invention have similar structure and shape. The rounded top head 106 comprises a central continuous opening 1060 surrounded by a tubular surface 1062. The tubular surface 1062 is used for scraping the dust and the dirt from a cavity created on a surface, and the central continuous opening 1060 is used for removing bigger pieces of stones and gravel. In an alternative embodiment, the tubular surface 1062 on the exterior surface can comprise metal bristles 1064, which allow for effective scraping and removal of the dust and dirt.

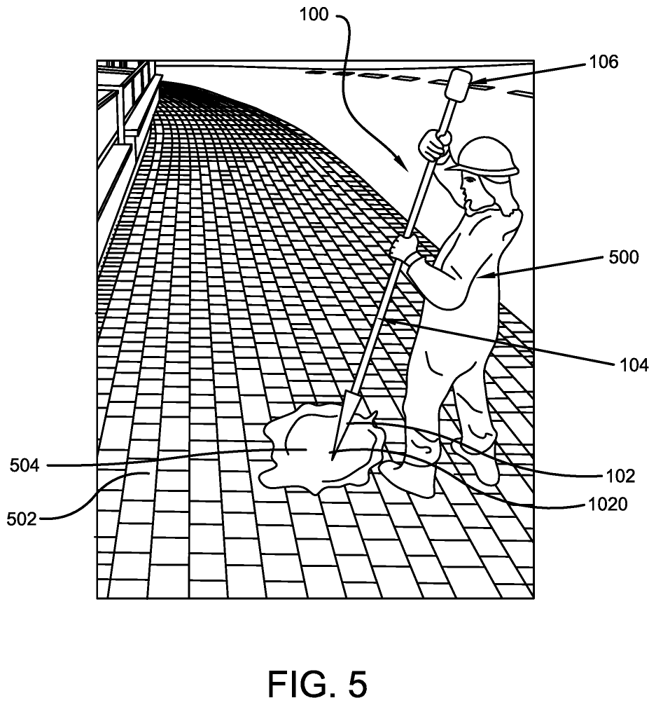

FIG. 5 illustrates the sidewalk digging bar device of the present invention in use for digging a cavity in a sidewalk. A user 500 holds the shaft 104 of the digging bar device 100 to excavate a portion of the sidewalk 502. The user 500 places the pointed tip 1020 on the sidewalk 502 and exerts a downward pressure. The pointed head 102 penetrates the surface, thereby allowing the user 500 to create a cavity 504. Thus, the digging bar device 100 is useful for tunneling under a sidewalk 502 to run irrigation lines, electrical wires, etc., or any other type of utilities as is known in the art. After excavating the cavity 504, the dirt and debris can be removed by using the rounded head 106 of the digging bar device 100.

Consequently, by incorporating a pointed head and the rounded top portion in the digging device 100, the present invention facilitates electricians, plumbers, lighting companies, irrigators, etc., in excavating the desired wiring and piping cavities with minimal effort and material waste. Further, the telescoping nature of the handle allows a plurality of users to conveniently use the bar device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sidewalk digging and boring bar device”, “sidewalk digging bar device”, “digging bar device”, “improved digging bar device”, and “metal digging bar device” are interchangeable and refer to the sidewalk digging bar device 100 of the present invention.

Notwithstanding the forgoing, the sidewalk digging bar device 100 of the present invention can be of any suitable size and configuration as is known in the art without affecting the overall concept of the invention, provided that it accomplishes the above-stated objectives. One of ordinary skill in the art will appreciate that the size, configuration and material of the sidewalk digging bar device 100 as shown in FIGS. 1-5 is for illustrative purposes only, and that many other sizes and shapes of the sidewalk digging bar device 100 are well within the scope of the present disclosure. Although the dimensions of the sidewalk digging bar device 100 are important design parameters for user convenience, the sidewalk digging bar device 100 may be of any size that ensures optimal performance during use and/or that suits a user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A digging bar device for excavating a cavity within a driveway, a sidewalk or another hard surface area, the digging bar device comprising:
an elongated shaft comprising a first end and a second end;
a pointed head secured to the first end of the elongated shaft; and
a rounded top element secured to the second end of the elongated shaft, wherein the pointed head is used to penetrate and excavate a surface to create a cavity, and further wherein the rounded top element is used to remove debris and excess dirt from the cavity.

2. The digging bar device of claim 1, wherein the pointed head is permanently secured to the first end of the elongated shaft.

3. The digging bar device of claim 2, wherein the pointed head is welded to the first end.

4. The digging bar device of claim 1, wherein the rounded top element is permanently secured to the second end of the elongated shaft.

5. The digging bar device of claim 4, wherein the rounded top element is welded to the second end.

6. The digging bar device of claim 1, wherein the pointed head, the elongated shaft and the rounded top element are cast together as a single piece component from same material.

7. The digging bar device of claim 1, wherein the pointed head comprises a pointed tip for excavating.

8. The digging bar device of claim 1 further comprising an ergonomic grip disposed along the elongated shaft.

9. The digging bar device of claim 1, wherein the elongated shaft is cylindrical in shape and comprises a constant diameter along its length.

10. The digging bar device of claim 9, wherein the elongated shaft is hollow.

11. A digging bar device for excavating a cavity within a hard surface area, the digging bar device comprising:
a telescoping shaft comprising a first end and a second end;
a pointed head comprising a flat top surface which secures to the first end of the telescoping shaft; and
a rounded top element secured to the second end of the telescoping shaft, wherein the pointed head is conical in shape with a pointed end which is used to penetrate and excavate the cavity, and further wherein the rounded top element is used to remove a debris and excess dirt from the cavity.

12. The digging bar device of claim 11, wherein the pointed head comprises a long and narrow pointed end which requires less force from a user to excavate the cavity.

13. The digging bar device of claim 11, wherein the telescoping shaft comprises a plurality of telescoping slots which allows the telescoping shaft to extend or retract.

14. The digging bar device of claim 11, wherein the rounded top element comprises a central continuous opening for removing a stone or gravel from the cavity.

15. The digging bar device of claim 14, wherein a tubular surface surrounds the central continuous opening, the tubular surface is used for scraping dust and dirt from the cavity.

16. The digging bar device of claim 15, wherein the tubular surface comprises a plurality of metal bristles on an exterior surface that allows for effective scraping and removal of a dust and dirt from the cavity.

17. The digging bar device of claim 11, wherein the pointed head is welded to the first end.

18. The digging bar device of claim 11, wherein the rounded top element is welded to the second end.

19. The digging bar device of claim 11, wherein the pointed head, the telescoping shaft and the rounded top element are cast together as a single piece component from a same material.

20. A method of utilizing a digging bar device comprising:
identifying a location for creating a cavity in a surface;
positioning a pointed tip which is permanently secured to a first end of a shaft of the digging bar device onto the location;
inserting the pointed tip into the location by applying a downward force on the shaft to create the cavity; and
removing a debris and dirt from said cavity using a rounded head that is permanently secured to a second end of the shaft.
